(19) United States
(12) Patent Application Publication
(10) Pub. No.: US 2023/0008512 A1
(43) Pub. Date: Jan. 12, 2023

(54) POLYURETHANE AND POLYISOCYANURATE FOAM AND METHOD OF MANUFACTURE THEREOF

(71) Applicant: Kingspan Holdings (IRL) Limited, Cavan (IE)

(72) Inventors: Patrick DE SCHYVER, Puurs-Sint-Amands (BE); Ruud ZEGGELAAR, Arnhem (NL); Ilse VAN BAEL, Hulshout (BE)

(21) Appl. No.: 17/764,460

(22) PCT Filed: Sep. 23, 2020
(86) PCT No.: PCT/EP2020/076580

§ 371 Date: Mar. 28, 2022

(30) Foreign Application Priority Data
Sep. 27, 2019 (GB) 1914004.5

(51) Int. Cl. C08G 18/08; C08G 18/12; C08G 18/02; C08G 18/18; C08G 18/24; C08G 18/16; C08G 18/40; C08G 18/42; C08G 18/48; C08J 9/00; C08J 9/12; C08J 9/14; C08K 5/02; C08G 77/46

(52) U.S. Cl. CPC C08G 18/14; C08G 18/12; C08G 18/022; C08G 18/1816; C08G 18/242; C08G 18/165; C08G 18/4018; C08G 18/4211; C08G 18/4829; C08G 18/4883; C08J 9/0019; C08J 9/127; C08J 9/141; C08J 9/146; C08J 9/148; C08J 9/125; C08J 9/149; C08K 5/02; C08G 77/46; C08G 2110/0025; C08G 2110/005; C08G 2101/00

(57) ABSTRACT

A method of producing a polyurethane or polyisocyanurate foam is provided which involves the use of a specific combination of hydrofluoroolefin blowing agents and cell nucleators. The resulting foams have excellent long term thermal insulating performance and have reduced thickness in comparison to conventional thermal insulating boards. The rigid polyurethane and polyisocyanurate boards may be used to insulate refrigeration bodies, such as those employed in vehicles comprising refrigeration units, and cold storage containers.

### FIELD

The present invention relates to thermal insulating foam, in particular polyurethane and polyisocyanurate thermal insulating foam. The foams of the present invention have excellent thermal insulation performance and are formed using blowing agents which have low environmental impact.

### BACKGROUND TO THE INVENTION

Rigid polyurethane and polyisocyanurate foams are important industrial products, which are used to as insulation products, to insulate for example walls, floors and roofs of buildings. In addition, polyurethane and polyisocyanurate foams are employed in appliances such as refrigerators and cold storage units, and said foams are also employed to insulate piping. Energy lost through the walls, roofs and windows accounts for the preponderance of energy lost in most buildings.

Polyurethane and polyisocyanurate foams are produced by reacting a polyisocyanate with a polyol in the presence of a blowing agent, a catalyst, a surfactant and optionally other ingredients. In polyisocyanurate foam manufacture cyclotrimerisation catalysts are employed, and the polyol is generally a polyester derived polyol. In contrast, in polyurethane foam manufacture the polyol is generally a polyether derived polyol. Polyisocyanurate foams typically have an isocyanate to polyol ratio higher than 180, whereas polyurethane foams generally have an isocyanate to polyol ratio of around 100.

Polymeric foams such as plastic foams may be formed by expanding a blowing agent in a polymeric matrix. Foams may be flexible or rigid depending on whether their glass transition temperature is below or above room temperature, which in turn depends on their chemical composition, the degree of crystallinity, and the degree of cross-linking in the polymeric matrix. The physical properties of the foam are greatly influenced by the properties of both the polymeric matrix, and any blowing agent retained within cells of the foam.

Blowing agents having low thermal conductivity are used to form thermal insulating foams. As the gas volume of a foam may account for up to about 95% of the volume of a foam, the amount and nature of the blowing agent trapped in the foam has a significant impact on the thermal insulating performance of the foam. In order to form thermal insulating foam, a total closed-cell content of greater than 85 percent is generally required, as one of the main determinants in the thermal performance of foam is the ability of the cells of the foam to retain blowing agent having a low thermal conductivity.

The density of the foam, which is directly linked to the amount of blowing agent retained within the foam, also greatly impacts the thermal insulating performance of the foam. Low density foams, having a density in the range of from 10 kg/m³ to about 80 kg/m³ may be used as insulating foams, however, the higher the density, the lower the greater the influence the polymeric matrix has on the thermal conductivity of the foam.

Two types of blowing agent may be used to form closed-cell thermal insulating polyurethane and polyisocyanurate foams. Physical blowing agents form cells by a phase change, a liquid may become gaseous in a polymeric matrix, or a gas may be dissolved in the polymer under high pressure. Chemical blowing agents are compounds that forms gaseous blowing agents by means of a chemical reaction or thermal decomposition such as the production of carbon dioxide as the result of the reaction of water and isocyanate groups.

Low boiling (typically below 50° C.) liquids, chlorofluorocarbons (CFC's) and hydrochlorofluorocarbons (HCFC's) have been widely used as physical blowing agents in plastic foams.

While CFC blowing agents were preferred in the 1980s as a consequence of their low thermal conductivity values, they have a detrimental effect on the environment and their use in foam production has been phased out in Europe as mandated by the Montreal Protocol. Hydrogenated chlorofluorocarbons (HCFCs) and hydrogenated fluorocarbons (HFCs) replaced CFCs but these agents are also being phased out due to environmental concerns. Hydrocarbon blowing agents which have a low environmental impact evolved as replacement blowing agents though hydrocarbons inherently have higher thermal conductivity values.

After the phase out of both CFC's and HCFC's, many producers switched to aliphatic and cycloaliphatic hydrocarbons, such as isomers of pentane, and to their chloro- and fluoro-derivatives, such as HFC-365mfc (1,1,1,3,3-pentafluorobutane)/HFC227ea (1,1,1,2,3,3,3-heptafluoropropane) or HFC-245fa (1,1,1,3,3-pentafluoropropane) as physical blowing agents, however resulting in relatively higher thermal conductivity. Hydrocarbons are also inherently flammable, thus the use of hydrocarbons as blowing agents may necessitate the inclusion of flame retardants to improve the fire performance of the resulting foam products.

By the mid-2000s Honeywell led the charge in the development of next generation hydrofluoroolefin blowing agents, which have low thermal conductivity, low or zero global warming potential and are non-flammable.

WO2007002703 is concerned with hydrofluoroolefin blowing agents, which have low or zero ozone depletion potential are non-flammable and have low thermal conductivity, and the use of such hydrofluoroolefins for the manufacture of thermoset and thermoplastic foams is described.

As outlined above, both the polymeric matrix and the blowing agent affect the thermal conductivity of the foam. A further influencing factor is the cell size and cell distribution in the foam. Nucleating agents may be employed to provide cell nucleation sites within a polymer, from which cells can grow. Importantly, minimizing coalescence of bubbles by controlling reaction parameters, facilitates the formation of foams having a small cell size. Traditionally, talc has been employed as a nucleating agent in the formation of polyurethane and polyisocyanurate foams, however, the use of solid particles can lead to sedimentation. More recently liquid nucleating agents have been described. Liquid nucleating agents form emulsions in foam manufacture. (Per)fluorinated hydrocarbons have demonstrated utility as liquid nucleating agents. Partially fluorinated compounds that have been introduced as replacements for CFCs and HCFC blowing agents have also been suggested as nucleating agents.

US Patent Application Publication No. 2014058003 of 3M Innovation Properties Company, describes fluorinated oxirane nucleating agents and foamable compositions comprising at least one blowing agents, a foamable polymer and said nucleating agent. Polyurethane foams manufactured using the fluorinated oxirane nucleating agents had reduced the cell size and lower thermal conductivity in comparison to foams manufactured using (per)fluorinated hydrocarbon nucleating agents.

### SUMMARY OF THE INVENTION

In one aspect, the present invention provides a method of producing a polyurethane or polyisocyanurate foam, by reacting and curing a foamable composition comprising:
a) at least one polyisocyanate,
b) at least one polyol component
c) a catalyst;
d) a blowing agent;
wherein the blowing agent comprises water and one or more halogenated hydroolefins selected from 1-chloro-3,3,3-trifluoropropene, 1-chloro-2,3,3,3-tetrafluoropropene, 1,3,3,3-tetrafluoropropene, 2,3,3,3-tetrafluoropropene and 1,1,1,4,4,4-hexafluoro-2-butene;
wherein the water is present in an amount of from 0.2 parts by weight to 1.5 parts by weight per 100 parts by weight polyol;
e) a surfactant; and
f) a cell nucleator, wherein the cell nucleator is one or more compounds having the formula:

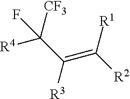

wherein R¹ is selected from —F, —CF₃, —CF₂CF₃ and —CF₂CF₂CF₃;
R² is selected from —F, CF₃, —CF₂CF₃ and —CF₂CF₂CF₃;
R³ is selected from —F, CF₃, —CF₂CF₃, —CF₂CF₂CF₃ and —CF(CF₃)₂; and
R⁴ is selected from —F, CF₃, —CF₂CF₃, —CF₂CF₂CF₃ and —CF(CF₃)₂.

Suitably, the water is present in an amount of from 0.8 parts by weight to 1.2 parts by weight per 100 parts by weight polyol.

The cell nucleator may have the formula:

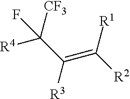

wherein R¹ is —F, or —CF₃;
R² is —F, or CF₃;
R³ is —F; and
R⁴ is CF₃.

Suitably, the molar ratio of the cell nucleator to the one or more halogenated hydroolefins is in the range of from 1:16 to 1:46, preferably from 1:28 to 1:40, such as from 1:30 to 1:40.

Preferably, the molar ratio of the cell nucleator to the one or more halogenated hydroolefins is in the range of from 1:16 to 1:46, preferably from 1:28 to 1:40.

The molar ratio of the cell nucleator to the water may be in the range of from 1:8 to 1:16, preferably from 1:9 to 1:14, such as from 1:10 to 1:12.

The molar ratio of the cell nucleator to the one or more halogenated hydroolefins may be in the range of from 1:28 to 1:40 and the molar ratio of the cell nucleator to the water may be in the range of from 1:9 to 1:14.

Suitably, the one or more halogenated hydroolefins comprises a chlorinated hydrofluoroolefin such as 1-chloro-3,3,3-trifluoropropene (1233zd) and/or 1-chloro-2,3,3,3-tetrafluoropropene (1224yd). The one or more halogenated hydroolefins may suitably be a non-chlorinated hydrofluoroolefin.

The blowing agent may further comprises a C₃-C₇ hydrocarbon selected from the group consisting of propane, butane, pentane, hexane, heptane and isomers thereof, including combinations thereof.

The blowing agent may be present in an amount of from about 15 to about 30 parts by weight per 100 parts by weight polyol, such as from about 18 to about 25 parts by weight per 100 parts by weight polyol.

Preferably, the blowing agent is present in an amount of from about 18 parts to about 25 parts by weight per 100 parts by weight polyol.

The catalyst comprises one or more amine catalysts and one or more organometallic catalysts.

The one or more amine catalyst may comprise a tertiary aliphatic amine.

The one or more organometallic catalysts may comprise one or more organotin compounds.

Suitably, the catalyst comprises an amine catalyst which is present in an amount of from about 0.3 to about 0.8 parts by weight per 100 parts by weight polyol.

When the catalyst comprises an organometallic catalyst, suitably, said organometallic catalyst is present in an amount of from about 0.5 to about 1.0 parts by weight per 100 parts by weight polyol.

Optionally, the foamable composition further comprise one or more of a fluorinated oxirane, a perfluorinated tetrahydropyran, a perfluorinated tetrahydrofuran, a perfluorinated fluorene, and m-chlorofluorobenzene.

The foamable composition may further comprise one or more additives selected from the group consisting of: fillers, pigments, dyes, antioxidants, flame retardants, hydrolysis control agents, antistats, fungistats and bacteriostats.

The surfactant may comprise a polyether-polysiloxane copolymer.

Suitably, the polyether-polysiloxane copolymer has a silicone content between 50 and 80% based on the total weight of the polyether-polysiloxane copolymer.

Preferably, the surfactant is present in an amount of from about 1 to about 3 parts by weight per 100 parts by weight polyol, such as from about 1.5 to about 2.8 parts by weight per 100 parts by weight polyol.

More preferably the surfactant has a hydrophilic to lipophilic balance (HLB) of between about 8 to about 15.5, suitably from about 10.5 to about 15.5, more suitably from about 10.8 to 15.5.

The foam has a closed cell content of at least 85% as determined in accordance with ASTM D 2856, suitably, the foam has a closed cell content of at least 90%, such as at least 95%, or at least 98%, as determined in accordance with ASTM D 2856.

The foam has a density in the range of from 10 kg/m³ to 100 kg/m³, suitably, the density is in the range of from 25 kg/m³ to 65 kg/m³, such as from 25 kg/m³ to 60 kg/m³, suitably in the range of from 30 kg/m³ to 45 kg/m³.

The foam has a thermal conductivity when determined in accordance with ASTM C 518 of 0.022 W/m.K or less, such as 0.018 W/m.K or less, at a mean temperature of 10° C.

The foam may be manufactured using a slabstock line, a boardstock foam laminator, or using a closed mould. Accordingly, the foam may be manufactured in a continuous processing line or discontinuously Thus the foam may be manufactured using a continuous slabstock line or for example a continuous boardstock foam laminator.

In another aspect, the present invention provides a rigid polyurethane or polyisocyanurate foam board, wherein a plurality of cells in said foam board comprise a halogenated hydroolefin and a cell nucleator, said foam board having a density in the range of from 25 kg/m³ to 65 kg/m³, a closed cell content as determined in accordance with ASTM D 2856 of at least 90%, and a thermal conductivity when determined in accordance with ASTM C 518 of 0.018 W/m.K or less, at a mean temperature of 10° C.; wherein the halogenated hydroolefin is selected from 1-chloro-3,3,3-trifluoropropene, 1-chloro-2,3,3,3-tetrafluoropropene, 1,3,3,3-tetrafluoropropene, 2,3,3,3-tetrafluoropropene and 1,1,1,4,4,4-hexafluoro-2-butene; and wherein the cell nucleator is one or more compounds having the formula:

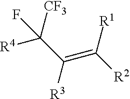

wherein R¹ is selected from —F, —CF₃, —CF₂CF₃ and —CF₂CF₂CF₃;
R² is selected from —F, CF₃, —CF₂CF₃ and —CF₂CF₂CF₃;
R³ is selected from —F, CF₃, —CF₂CF₃, —CF₂CF₂CF₃ and —CF(CF₃)₂; and
R⁴ is selected from —F, CF₃, —CF₂CF₃, —CF₂CF₂CF₃ and —CF(CF₃)₂.

Suitably, the cell nucleator has the formula:

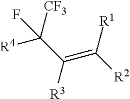

wherein R¹ is —F, or —CF₃;
R² is —F, or CF₃;
R³ is —F; and
R⁴ is CF₃.

Preferably the cell nucleator is

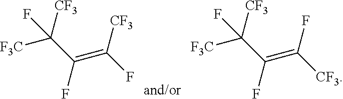 [SMILES: F/C(=C(\F)C(F)(C(F)(F)F)C(F)(F)F)C(F)(F)F ; F/C(=C(/F)C(F)(C(F)(F)F)C(F)(F)F)C(F)(F)F]

Suitably, the rigid polyurethane or polyisocyanurate foam board of the invention has a compressive strength in a thickness direction, which is lower than a compressive strength in a width direction and lower than a compressive strength in a length direction, wherein said compressive strengths are determined in accordance with EN826 for a cubic sample of the foam derived from a panel of the foam, said panel being substantially cuboid or parallelepiped in shape, said panel having a thickness, width and length, and wherein the thickness of the cube is derived from the thickness of the panel, the width of the cube is derived from the width of the panel and the length of the cube is derived from the length of the panel, and wherein the compressive strength in the thickness direction is the compressive strength across the thickness of the cubic foam sample; the compressive strength in a width direction is the compressive strength across the width of the cubic foam sample, and the compressive strength in a length direction is the compressive strength across the length of the cubic foam sample.

Advantageously, the specific combination of blowing agent and cell nucleator in method of the present invention provides thermal insulating boards with excellent long term thermal insulation performance. The foam boards formed by the method of the invention are particularly suitable for insulating vehicles and for insulating cold storage units. For example, the foam boards of the invention have low thermal conductivity and as such boards of the present invention having reduced thickness in comparison to prior art boards may be used to insulate refrigerated vehicles such as refrigerated trucks without impinging on the loading space in the truck. Furthermore, the boards formed by the method of the invention will also have reduced mass in comparison to thicker conventional insulating boards which has the added benefit of reducing energy consumption due to reduced fuel consumption of the vehicle. Furthermore, less energy is required to cool the refrigerated compartment of the truck due to the excellent insulation performance of the boards insulating the refrigerated compartment.

In a further aspect, the present invention provides a refrigeration body comprising walls, a floor and a roof, at least one of said walls, floor or roof comprising one or more thermal insulating boards, wherein said one or more thermal insulating boards comprise one or more rigid polyurethane or polyisocyanurate foam boards as described herein.

In yet another aspect the present invention provides a vehicle comprising a refrigeration body as described herein.

The rigid polyurethane and/or polyisocyanurate foam boards of the present invention may also be used to insulate cold storage units.

In still yet a further aspect the present invention provides an external thermal insulation composite system (ETICS) comprising a rigid polyurethane and/or polyisocyanurate foam board as described herein. In particular the present invention provides an ETICS comprising a thermal insulating layer, fastening means and a finishing layer, wherein the thermal insulating layer comprises a rigid polyurethane or polyisocyanurate foam board according to the present invention.

The present invention also provides an insulated building wall comprising an ETICS as described herein, and a building wall, wherein the ETICS is affixed to the building wall.

### BRIEF DESCRIPTION OF THE DRAWINGS

Embodiments of the invention will be described, by way of example only, with reference to the accompanying drawings in which:

FIG. 1 shows a slabstock processing line for forming polyurethane or polyisocyanurate foam.

FIG. 2 shows a foam bun formed using a slabstock processing line, and the directionality of the foam bun is shown to highlight ways in which foam boards may be cut from the bun.

FIG. 3 shows a foam bun such as that in FIG. 2 albeit an alternative cutting directionality is shown.

FIG. 4 shows a foam board from FIG. 3, and the orientation of cells across the thickness of the board.

FIG. 5 shows an ETICS of the present invention.

### DETAILED DESCRIPTION

Suitable testing methods for measuring the physical properties of phenolic foam are described below.

### (i) Foam Density:

This was measured according to BS EN 1602:2013—Thermal insulating products for building applications—Determination of the apparent density.

### (ii) Thermal Conductivity:

A foam test piece of length 300 mm and width 300 mm was placed between a high temperature plate at 20° C. and a low temperature plate at 0° C. in a thermal conductivity test instrument (LaserComp Type FOX314/ASF, Inventech Benelux BV). The thermal conductivity (TC) of the test pieces was measured according to EN 12667: “Thermal performance of building materials and products—Determination of thermal resistance by means of guarded hot plate and heat flow meter methods, Products of high and medium thermal resistance”.
   (iii) Thermal Conductivity After Accelerated Ageing:
This was measured using European Standard BS EN 13166:2012—“Thermal insulation products for buildings—Factory made products of phenolic foam (PF)”. The thermal conductivity is measured after exposing foam samples for 25 weeks at 70° C. and stabilisation to constant weight at 23° C. and 50% relative humidity. This thermal ageing serves to provide an estimated thermal conductivity for a time period of 25 years at ambient temperature. Alternatively samples may be heat aged for 14 days at 110° C. Details for thermal ageing and determination of thermal conductivity are specified in Annex C section C.4.2. The mean plate temperature was 10° C.

### (iv) Closed-Cell Ratio:

The closed-cell ratio was determined according to ASTM D6226 test method.

### (vi) Compressive Strength:

The compressive strength was measured according test method EN 826 unless otherwise specified.

### (v) Viscosity:

The viscosity was measured using a Brookfield viscometer (model DV-II+Pro) with a controlled temperature water bath, maintaining the sample temperature at 25° C., with spindle number S29 rotating at 20 rpm;

### (vi) HLB Value: Hydrophilic Lipophilic Balance of Surfactant

The HLB value has been estimated by ¹H-NMR spectrum through integration of the proton signals from the lipophilic and hydrophilic parts of the molecule. The region of 3.0-5.0 ppm is designated as the hydrophilic region and all other peak containing regions were designated lipophilic. Taking integration values about these regions the HLB was estimated using the equation of Berguerio et al (J. R. Berguerio, M. Bao, J. J. Casares, Anal. Quim. 1978, 74, 529-530; 1941-1942).

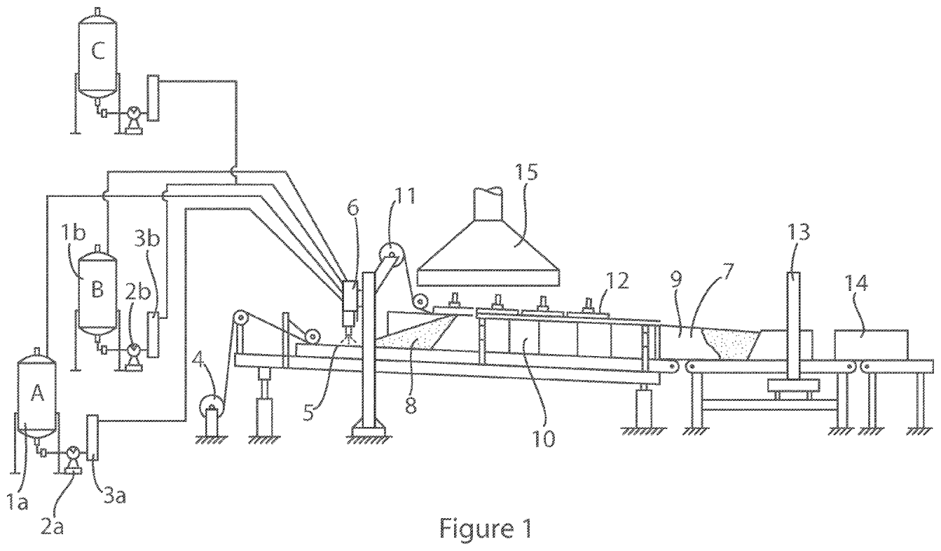

FIG. 1 shows a slabstock line for manufacturing a foam of the present invention. Tanks A and B (1a, 1b) contain the reactive components which are metered through conduits by metering pumps (2a, 2b) to the mixing head (6). Tank A comprises the isocyanate component. Tank B contains the polyol component, catalyst, surfactant, water, fire retardant and the cell nucleator. The mixture conveyed from tank B passes through a heat exchanger (3b) en route to the mixing head, and its temperature is set in the range of from 19 and 21° C. Blowing agent is conveyed from a third tank, tank C, by a metering pump (2c) through a heat exchanger (3c) where it is cooled to within the range of from 13 to 15° C., and subsequently fed into the conduit conveying the polyol component (i.e. the mixture from tank B) upstream from the mixing head. A static mixer (not shown) in the conduit blends the blowing agent with the mixture conveyed from tank B, prior to the resulting mixture entering the mixing head, where it is mixed with the isocyanate component which is conveyed through conduits from tank A to the mixing head by metering pump (2a). A foamable composition is deposited from the mixing head onto a moving facer (e.g. Kraft paper) fed from spool (4) at the laydown on a lower conveyor (5); this becomes the lower facer of the block foam. The mixing head (6) comprises mixing blades rotating in the range of from 3000 to 7000 rpm, suitably at 5500 rpm. Once deposited, the foamable composition begins to rise in the rise zone (8), as the blowing agent expands within the polymeric resin formed through the reaction of the isocyanate component with the polyol component. Expansion of the blowing agent occurs as a consequence of heat generated by the exothermic reaction between the isocyanate component and the polyol component. A moving facer (e.g. Kraft paper) is applied to the upper surface of the rising foam from spool (11). This facer becomes the upper facer on the block foam. Pressure is applied to the upper facer to control the rise of the foam. This can be achieved by placing weights on mats/pans (12) which are in direct contact with the upper facer. Side conveyors (10) determine the width of the block by containing the expanding foam, and defining the width of the channel in which the foam expands on the processing line. Polyethylene plastic (9) which is fed from rolls along the side conveyors protects the side conveyors from the rising foam. The lower conveyor, side conveyors and mats/pans which are employed to apply pressure to the upper facer on the surface of the expanding foam, form the cure zone. The lower conveyor and side conveyors move at a rate of approximately 3 to 4 metres per minute. The lower facer and upper facer move in the machine direction with the forming foam. The liquid foaming reactants which are deposited on the lower facer expand in the horizontal direction to fill the space defined by the two side conveyors; and in the vertical direction (i.e. the rise direction). Expansion in the rise direction is controlled by applying pressure to the mats/pans on the upper facer which is in contact with the upper surface of the rising foam. This is important to prevent punking, furthermore, uncontrolled expansion leads to the formation of open cell foam. The expanded foam i.e. the block foam (7), is conveyed from the cure zone to the dry zone (13), where the upper and lower facers are removed and saws cut the block to form foam buns (14), (so called due to the bun shaped crest on the upper surface of the block foam). While the size of a foam bun can vary, typically foam buns are formed which have the following dimensions: l (2500 to 6500 mm)×b (900 to 1400 mm)×h (300 to 1000 mm). Fumehood (15) removes any escaping volatiles.

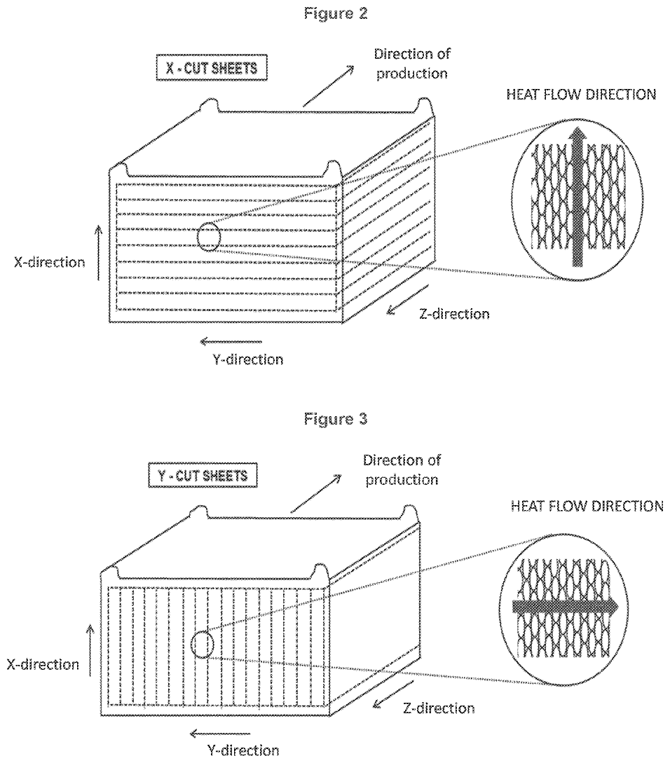

FIG. 2 shows a foam bun formed using a slabstock processing line. The bun results from cutting a continuous foam block which emerges from the cure zone of the slabstock processing line. The bun may for example be cut into foam boards which may be used to insulate refrigerated vehicles. FIG. 2 shows how foam boards such as substantially parallelepiped foam boards can be formed by cutting the foam bun in a particular direction. The vertical direction in which the foam expanded is referred to as the rise direction, this corresponds with the vertical X-axis of the foam bun. On the slabstock line, foamable reactants expand to form a continuous foam block which is conveyed along the length of the slabstock line in a machine direction. The continuous foam block is cut to form foam buns having a length, width and height, with the width of a foam bun corresponding to the width of the foam block from which the bun was cut, and the height of the foam bun corresponding with the height of the foam block from which the bun was cut. The foam bun has a vertical X-axis, a horizontal Y-axis and a longitudinal Z-axis. The X-axis of the foam bun corresponds with the vertical axis in the rise direction of the foam block from which the bun was cut, the Y-axis of the foam bun corresponds with the horizontal axis along the width of the foam block from which the foam bun was cut, and the Z-axis of the foam bun corresponds with the longitudinal axis along the machine direction of the foam block from which the foam bun was cut.

FIG. 2 shows how foam boards may be formed by cutting from the foam bun along its longitudinal Z-axis and horizontal Y-axis, to generate substantially parallelepiped boards. The cells of the foam boards are elongated across the thickness of the foam board (see Heat Flow Direction diagram).

FIG. 3 shows how foam boards such as substantially parallelepiped foam boards can be formed by cutting the foam bun in an alternative direction to those in FIG. 2, and the resulting cell orientation across the thickness of the resulting foam boards. In FIG. 3, foam boards are formed by cutting the foam bun along the X-axis and Y-axis. The maximum width of the foam boards is limited by the height of the foam bun from which the boards are cut. The cells of the foam boards are elongated across the width of the foam board.

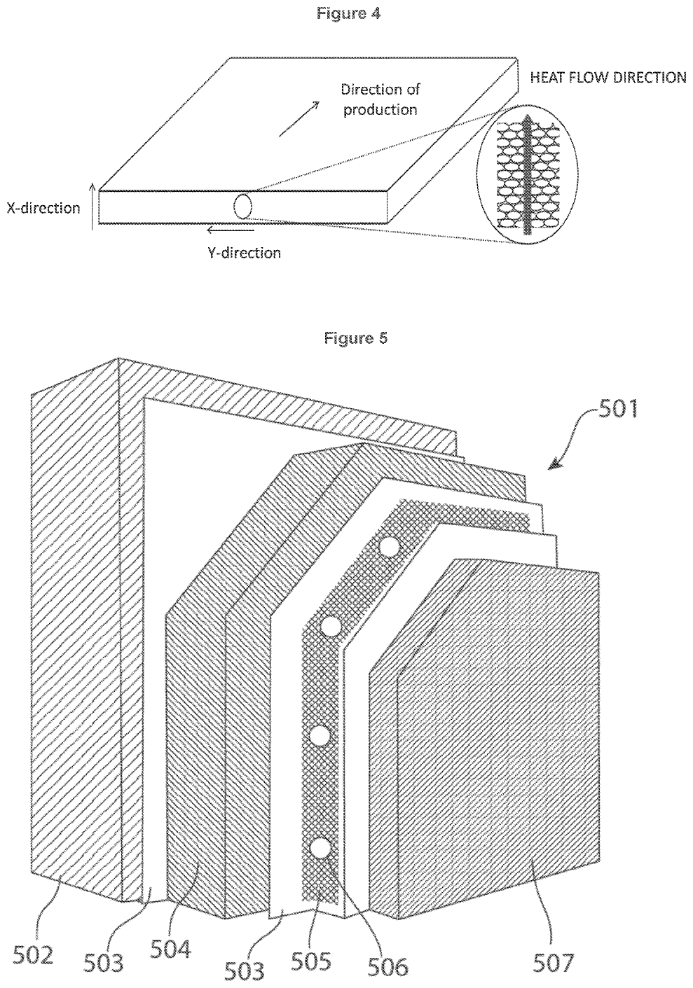

FIG. 4 shows a foam board cut as provided in FIG. 3.

The thermal conductivity of boards cut as provided in FIG. 3 is lower than that for boards cut in the manner shown in FIG. 2, due to the anisotropy of the cells of the foam board. This may be explained by there being less foam resin across the thickness of the foam board i.e. a shorter thermal bridge for the foam boards cut in FIG. 2, whereas the orientation of the elongated cells in the boards of cut in the manner shown in FIG. 3 have a longer thermal bridge.

The polyurethane and polyisocyanurate foams of the present invention are particularly useful as insulating layers in ETICS.

An ETICS generally comprises an insulation layer attached to an outer surface of a wall, with an exterior finishing layer attached to the insulation layer. The insulation layer may be adhered to the outside wall by means of dowels, anchors or adhesive. On the outer surface of the insulation layer, a finishing layer is provided which finishing layer for instance comprises different plaster layers possible with reinforcing elements or other suitable finishing layers (e.g. mineral or polymer based plasters). This type of external wall insulation system is for example used to thermally insulate existing or newly built buildings. Such systems are known where the insulation consists for example of expanded polystyrene, mineral wool, phenolic foam, vacuum panels and polyisocyanurate/polyurethane. A drawback of expanded polystyrene and mineral wool systems is that relatively thick insulation layers are required to provide a sufficient degree of insulation. Such thick insulation layers result in the ETICS being of significant thickness, which is not desirable particularly around openings in the wall such as at doors and windows, and a thick ETICS can consequently lead to reduced internal light in the building. Furthermore, external wall insulation systems having a large thickness may result in a decreased available lot surface around the wall. ETICS comprising phenolic foam or and vacuum insulation panels as insulation layers are comparatively more expensive than those where the insulation layer comprises expanded polystyrene foam or polyurethane/polyisocyanurate foam.

The thermal conductivity of standard polyurethane solutions range from 0.024 to 0.027 W/m.K (declared lambda according EN13165). The advantage over EPS systems with declared lambda's down to 0.029 W/m.K is limited. PIR foams offer improved fire performance over traditional EPS systems.

Importantly, the PIR/PUR foams of the present invention offer significant benefits for use in ETICS, as the PI R/PUR foams of the present invention have excellent thermal insulation properties and reduced thickness in comparison to prior art foam boards.

Furthermore, the use of block foams, such as those manufactured on a slabstock processing line have additional advantages over laminated boards due to the very narrow thickness tolerances in ETICS. Laminate foam boards generally have facing materials, the presence of which can lead to problems when adhering render to said foam boards, and/or when adhering said foam boards to an underlying wall. Poor adherence strength may lead to delamination of the insulation and/or render over time. In contrast form foam boards cut from block foams do not have a facing material and consequently do not suffer from such adherence problems, and therefore are particularly useful as insulating layers in ETICS.

A further advantage of polyurethane and/or polyisocyanurate foam boards of the invention which are manufactured from block foam is the cell orientation makes the foam more resistant to shrinkage. Foam shrinkage can result in deformations around join lines between abutting foam insulation layers of an ETICs, and such deformations can be visible from the exterior of the ETICs as shadowing.

FIG. 5 shows an ETICS of the present invention 501. The ETICS comprises an insulation layer (504) of polyurethane/polyisocyanurate foam of the present invention which is attached to wall (502) optionally by an adhesive layer (503). A reinforcement mesh (505) is bound to the insulation layer (504) by mechanical ties (506) and optionally an adhesive layer (503). A finishing layer of render (507) is applied to the reinforcing mesh (505).

### Reactants

The organic polyisocyanates a) can be any organic di- and polyisocyanates known to a person skilled in the art, preferably aromatic polyfunctional isocyanates.

Specific examples are 2,4- and 2,6-toluene diisocyanate (TDI) and the corresponding isomeric mixtures, 4.4-2,4′- and 2,2′-diphenylmethane diisocyanate (MDI) and the corresponding isomeric mixtures, mixtures of 4,4′- and 2,4′-diphenylmethane diisocyanates, polyphenyl polymethylene polyisocyanates, mixtures of 4,4′-, 2,4′- and 2,2′-diphenylmethane diisocyanates and polyphenyl polymethylene polyisocyanates (polymer MDI) and mixtures of polymer MDI and toluene diisocyanates. The organic di- and polyisocyanates can be used individually or in the form of mixtures. So-called modified polyfunctional isocyanates, i.e., products obtained by chemical conversion of organic di- and/or polyisocyanates, are also frequently used. Examples include di- and/or polyisocyanates comprising uretdione, carbamate, isocyanurate, carbodiimide, allophanate and/or urethane groups. Modified polyisocyanates may optionally be mixed with each or one another or with unmodified organic polyisocyanates such as, for example, 2,4′-diphenylmethane diisocyanate, 4,4′-diphenylmethane diisocyanate, polymer MDI, 2.4- and/or 2,6-tolylene diisocyanate.

Also suitable are “prepolymers” of these polyisocyanates comprising a partially prereacted mixture of a polyisocyanate and a polyether or polyester polyol. Preferably the above polyisocyanates are used in an isocyanate index range of 80 to 400.

A particularly advantageous organic polyisocyanate is polymeric MDI, especially with an NCO content of 29% to 34% by weight and a viscosity at 25° C. in the range from 100 to 1000 mPa·s

The at least one polyol component b) can be any polyol component comprising at least two reactive groups, preferably OH groups, especially polyether alcohols and/or polyester alcohols having OH numbers in the range from 25 to 800 mg KOH/g and especially 100 mg KOH/g to 600 mg KOH/g. Polyol component b) comprises more particularly polyetheralcohols prepared by known processes, for example by anionic polymerization of alkylene oxides on H-functional starter substances in the presence of catalysts, preferably alkali metal hydroxides or double metal cyanide (DMC) catalysts.

The alkylene oxides used are usually ethylene oxide or propylene oxide, but also tetrahydrofuran, various butylene oxides, styrene oxide, preferably straight 1,2-propylene oxide. The alkylene oxides can be used individually, alternatingly in succession or as mixtures.

The polyol substances used are more particularly compounds having at least 2 and preferably from 2 to 8 hydroxyl groups, It is preferable to use trimethylolpropane, glycerol, pentaerythritol, sugar compounds such as for example glucose, sorbitol, mannitol and sucrose, polyhydric phenols, resoles, for example oligomeric condensation products formed from phenol and formaldehyde and Mannich condensates formed from phenols, formaldehyde and dialkanolamines, and also melamine, or having at least two primary amino groups in the molecule, it is preferable to use aromatic di- and/or polyamines, for example phenylenediamines, and 4,4′-, 2,4′- and 2,2′-diaminodiphenylmethane and also aliphatic di- and polyamines, such as ethylenediamine.

In a preferable embodiment of the process according to the present invention, the polyol component b) comprises at least one polyether alcohol having a hydroxyl number in the range between 350 and 600 and a functionality in the range between 3.5 and 5.5. This polyether alcohol is preferably prepared by addition of ethylene oxide and/or propylene oxide, preferably propylene oxide, onto H-functional starter substances. The starter substances used are preferably the above-recited sugars, especially sucrose or sorbitol. Typically, the sugars are reacted with the alkylene oxides in the presence of so-called co-starters, usually room temperature liquid 2- or 3-functional alcohols, such as glycerol, trimethylolpropane, ethylene glycol, propylene glycol, or water. Catalysts used are typically basic compounds, preferably potassium hydroxide or amines.

Alternatively, the polyether alcohol may consist of a mixture of at least one primary polyether alcohol having a hydroxyl number in the range between 400 and 600 and a functionality in the range between 4.5 and 6.5 which is preferably prepared by addition of ethylene oxide and/or propylene oxide, preferably propylene oxide, onto H-functional starter substances being preferably the above-recited sugars, especially sucrose or sorbitol and of at least one secondary polyether alcohol having a hydroxyl number in the range between 200 and 800 and a functionality of 3 which is prepared by addition of ethylene oxide and/or propylene oxide, preferably propylene oxide, onto H-functional starter substances being preferably 3-functional alcohols, such as glycerol or trimethylolpropane.

The optionally used polyester alcohols, as co-polyol next to the polyether polyol fraction, are usually prepared by condensation of polyfunctional alcohols, preferably diols like DEG, having 2 to 12 carbon atoms and preferably 2 to 6 carbon atoms with polyfunctional carboxylic acids having 2 to 12 carbon atoms, for example succinic acid, glutaric acid, adipic acid, suberic acid, azelaic acid, sebacic acid, decanedicarboxylic acid, maleic acid, fumaric acid and preferably phthalic anhydride (PA), phthalic acid, isophthalic acid, terephthalic acid and the isomeric naphthalenedicarboxylic acids. Additionally, the optionally polyester alcohols can be prepared based on recycled polyethyleneterephtalate (PET), dimethylterephtalate (DMT) or a combination of PA and/or PET and/or DMT based polyesterpolyols. The said polyester alcohol has a hydroxyl number in the range between 150 to 350 and a functionality in the range between 2 and 3.

The process according to the present invention is carried out in the presence of a surfactant (i.e. a surface-active substance) to stabilize the cells and to keep their size as low as possible as formed by the said combination of blowing agent and nucleator. The surfactant substance is preferably a silicone surfactant (polyether-polysiloxane copolymer), particularly silicone surfactants manufactured by Momentive under the Niax tradename such as Niax L-5162, and similar surfactants. The silicone surfactant may comprise a polyether-polysiloxane copolymer with a polyether content between 50 and 85 wt %, suitably the polyether component of the polyether-polysiloxane copolymer is a polyalkyl ether, such as ethylene oxide, propylene oxide and/or co-polymers thereof. More suitably, the polyether-polysiloxane copolymer has a polyether content between 60 and 82 wt %. Suitably, the surfactant is present in an amount of from 1.5 to 3 parts by weight per 100 parts by weight of polyol.

Catalysts used are more particularly compounds that have a substantial speeding effect on the reaction of isocyanate groups with isocyanate-reactive groups. Examples of such catalysts are amines, such as tertiary aliphatic amines, and organometallic compounds, especially those based on tin, zinc and/or bismuth. In the present invention, a catalyst system consisting of a mixture of tertiary amines combined with an organometallic catalyst may be used. Suitably, the catalyst system for forming a polyurethane foam comprises a mixture of N,N-dimethylcyclohexylamine and pentamethyldiethylenetriamine with dibutyltin dilaurate.

When isocyanurate groups are to be incorporated in the rigid polyurethane foam, specialty catalysts are preferred. Suitable catalysts for isocyanate cyclotrimerisation are disclosed in Table 6.3 of Klempner “Polymeric Foams and Foam Technology” 2^{nd} Edition. Preferred catalysts include potassium acetate and/or potassium octoate, such catalysts may optionally be dissolved in glycol and/or water. The catalysts can be used alone or in any desired mixtures with each or one another, as required.

Useful auxiliaries and/or added substances include the materials known for this purpose, examples being fillers, pigments, dyes, antioxidants, flame retardants, hydrolysis control agents, antistats, fungistats and bacteriostats.

The foam of the present invention may be industrially produced on a typical continuous slabstock line comprising a wet end, a rise zone and a dry end. The wet end comprises metering units for all chemical components, a mixing head and a laydown and distribution system. Cure zone comprises a lower conveyor, two side belts and several mats or pans to flatten the top side of the foamed block. The dry end comprises a curing zone and a cross cut. The slabstock process may be modified to produce blocks of varying height, width and length.

The process to convert the final block to sheets comprises a milling machine to remove the skin of the block, a cutting line to cut the block to sheets perpendicular to the rise direction and optionally a milling machine to further optimize the dimensions to more stringent tolerances. Preferably, the cutting line cuts the block to sheets in the machine direction, i.e. in the direction perpendicular to the rise direction and perpendicular to the width of the foam block.

Alternatively, the foam of the present invention may be industrially produced on a typical continuous boardstock line comprising a wet end, a rise zone and a dry end. The wet end comprises metering units for all chemical components, a mixing chamber and a laydown and distribution system. The cure zone comprises a double conveyor with the possibility to apply an external pressure on the foam, by varying the spacing between the conveyors. The dry end comprises a curing zone and a cross cutting tool. The boardstock process may be varied to produce blocks of varying height, width and length.

The process to convert the final block board to sheets comprises equipment to remove top and bottom facer of the board and optionally a milling machine to further optimize the dimensions to more stringent tolerances.

The foam of the present invention may also be industrially produced in a typical discontinuous moulding process comprising a mould for curing the foam to the linings. The wet end comprises metering units for all chemical components, a mixing chamber and optionally a laydown and distribution system. The cure zone comprises an open or a closed mould. Foams of variable length, width and thickness may be formed.

### EXAMPLES

The foams of table 1 were manufactured using a slabstock processing line.

The term X-cut means that the foam board/sheet was cut from a foam bun such that the thickness of the foam board/sheet is derived from the rise direction (i.e. height) of the foam bun (See FIG. 2).

The term Y-cut means that the foam board/sheet was cut from a foam bun such that the thickness of the foam board/sheet is derived from the width of the foam bun (See FIG. 3).

The term Z-cut means that the foam board/sheet was cut from a foam bun such that the thickness of the foam board/sheet is derived from the machine direction (i.e. length) of the foam bun.

TABLE 1

| Example | | 1 | 2 | 3 | 4 |
|---|---|---|---|---|---|
| Polyol 1 | pbw | 83.6 | 83.6 | 83.6 | 83.6 |
| Polyol 2 | pbw | 16.4 | 16.4 | 16.4 | 16.4 |
| Fire retardant | pbw | 14.2 | 14.2 | 14.2 | 14.2 |
| Catalyst 1 | pbw | 0.6 | 0.5 | 0.6 | 0.5 |
| Catalyst 2 | pbw | 0.8 | 0.9 | 0.8 | 0.9 |
| Surfactant | pbw | 2.2 | 2.7 | 2.2 | 2.7 |
| Water | pbw | 1.0 | 1.0 | 1.0 | 1.0 |
| FA188 | pbw | 0.0 | 0.6 | 0.0 | 1.6 |
| Solstice Iba | pbw | 0.0 | 0.0 | 21.9 | 21.9 |
| Hydrocarbon | pbw | 10.9 | 10.9 | 0.0 | 0.0 |
| Polymeric | pbw | 139.9 | 139.9 | 139.9 | 139.9 |
| MDI | | | | | |
| Isocyanate | — | 115 | 115 | 115 | 115 |
| Index | | | | | |
| Density | Kg/m³ | 39.4 | 34.3 | 38.8 | 38.5 |
| Thermal | mW/ | 20.4 | 19.9 | 18.4 | 17.4 |
| conductivity | m · K | | | | |
| X-cut | | | | | |
| Thermal | mW/ | 19.4 | 18.8 | 17.3 | 16.4 |
| conductivity | m · K | | | | |
| Y-cut | | | | | |
| Compressive | kPa | 269 | 216 | 251 | 232 |
| strength CST | | | | | |
| Compressive | kPa | 168 | 123 | 146 | 145 |
| strength CSW | | | | | |
| Compressive | kPa | 229 | 189 | 198 | 204 |
| strength CSL | | | | | |
| Ratio | — | 1.6 | 1.76 | 1.72 | 1.6 |
| CST/CSW | | | | | |
| Ratio | — | 1.17 | 1.14 | 1.27 | 1.14 |
| CST/CSZ | | | | | |

Key to Table 1
Polyol 1 is a polyether polyol with IOH 490 mg KOH/g, molecular weight 530 g/mol, functionality 4.5 and a viscosity of 9500 cP at 25° C. Polyol 1 is based on the combination of sucrose and glycerol.
Polyol 2 is a polyesterpolyol based on phthalic anhydride and DEG with IOH 195 mgKOH/g, functionality 2.0 and a viscosity of 3000 cP at 25° C.
Fire Retardant is Levagard PP (Lanxess).
Catalyst 1 is a mixture of N,N-dimethylcyclohexylamine (73 wt %) and pentamethyldiethylenetriamine (27 wt %) resp. Polycat 8 and Polycat 5 (Evonik)
Catalyst 2 is a diluted dibutyltindilaurate, Dabco® T-12 (Evonik) or Dabco T2064.
Surfactant is Niax L5162 (Momentive).
FA188 (3M) is a mix of both isomers of 1,1,1,2,3,4,5,5,5-nonafluoro-4-trifluoromethyl-pent-2-ene.

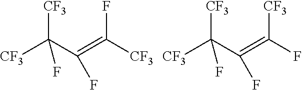 [SMILES: F/C(=C(/F)C(F)(C(F)(F)F)C(F)(F)F)C(F)(F)F ; F/C(=C(\F)C(F)(C(F)(F)F)C(F)(F)F)C(F)(F)F]

Solstice LBA or Solstice 1233zd(E) (Honeywell) is trans-1-chloro-3,3,3-trifluoro-1-propene.

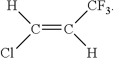

Hydrocarbon is a mix of 70 wt % cyclopentane and 30 wt % isopentane (Haltermann).
Polymeric MDI is Lupranate M70R (BASF).
Density, expressed as kg/m³, is the average result of 4 individual measurements at different locations.
Thermal conductivity X-cut, expressed as mW/mK, measured at 10° C., sample size (300×300×50)mm where the 50 mm is taken in the rise direction (X or height of the block), is the average result of 4 individual measurements at different locations.
Thermal conductivity Y-cut, expressed as mW/mK, measured at 10° C., sample size (300×300×50)mm where the 50 mm is taken in the direction perpendicular to rise (Y or width of the block), is the average result of 4 individual measurements at different locations.
Compressive strength was determined across the thickness, width and length of a cubic sample of foam derived from a panel of foam having a thickness, width and length, wherein the thickness of the cubic sample is derived from the thickness of the foam panel, the width of the cubic sample is derived from the width of the foam panel and the length of the cubic sample is derived from the length of the foam panel. A cubic sample having side edge of fixed length (e.g. 50 mm) is cut from a panel and the sides of the sample cube are labeled as being derived from the thickness of the panel, the width of the panel and the length of the panel.
Compressive strength thickness (CST), expressed as kPa, sample size (50×50×50)mm—this is a measure of the pressure needed to compress the sample for 10% which is the average result of 4 individual measurements.
Compressive strength width (CSW), expressed as kPa, sample size (50×50×50)mm—this is a measure of the pressure needed to compress the sample for 10% and is the average result of 4 individual measurements.
Compressive strength length (CSL), expressed as kPa, sample size (50×50×50)mm—this is the pressure needed to compress the sample for 10% and is the average result of 4 individual measurements.
The compressive strength of each sample was measured in accordance with the methodology described in EN826, albeit the compressive strength is measured across across each of the dimensions of a a cubic sample cut from a panel having a thickness, width and length. As outlined above, the sides of the cubic sample are labeled so as to identify their origin relative to the dimensions of panel from which they are cut.
Depending on how the panel is cut from a block foam/foam bun, the ratio of compressive strengths in different dimensions will vary. For a given cubic sample derived from a panel, if CST is the largest of the three compressive strength values (i.e. of CST, CSW and CSL), the panel is an X-cut panel. If CST is the lowest of the three compressive strength values (i.e. of CST, CSW and CSL), the panel is a Y-cut panel. If CST is in between the other two compressive strength values, the panel is a Z-cut panel. If CST:CSW is greater than 1, and if CST:CSL is greater than 1, the panel is an X-cut panel.
Accordingly, if the origin of a panel is unknown, the direction in which the panel was cut from a block foam from which it is derived can be determined by analysing the compressive strength values across the thickness, width and length of a cubic sample cut from the panel—noting the derivation of each of the sides of the cube i.e. the thickness of the cube is derived from the thickness direction of the panel etc.

### Example 1

The foam of example 1, is a standard foam blown with water and a mixture of hydrocarbons with an apparent density of approximately 40 kg/m³. The foam is made on a slabstock processing line. This example indicates a significant reduction in thermal conductivity (i.e. improved thermal insulation performance) when the foam board/sheet is cut from the foam block/bun such that the thickness of the board is derived from the width of the foam block/bun; i.e. thermal conductivity values for Y-cut boards are lower than thermal conductivity for X-cut boards.

### Example 2

The foam of example 2 is a foam blown with water and a mixture of hydrocarbons with an apparent density of approximately 35 kg/m³. This foam was manufactured in the same manner as Example 1. This example indicates a reduction in thermal conductivity introducing FA188 (0.5 mW/mK), using optimized surfactant and water level when cutting the sheet in Y-direction instead of the X-direction due to the elongated cells in foaming direction (another 1.0 to 1.1 mW/mK reduction in thermal conductivity is achieved).

### Example 3

The foam of example 3, is a foam blown with water and Solstice LBA with an apparent density of approximately 40 kg/m³. This example indicates both a significant decrease in thermal conductivity by replacing hydrocarbons with hydrofluoroolefin and a significant reduction in thermal conductivity when cutting the sheet in Y-direction instead of the X-direction due to the elongated cells in foaming direction.

### Example 4

The foam of example 4, is a foam blown with water and Solstice LBA with an apparent density of approximately 40 kg/m³. This example indicates a surprisingly large decrease in thermal conductivity by replacing hydrocarbons with hydrofluoroolefin, adding a specific cell nucleator, using the optimized water level. Advantageously, the thermal conductivity of the boards of example 4 is significantly lower than what might have been expected, based on an additive effect of replacing a hydrocarbon with a hydrofluoroolefin, or adding a cell nucleator as defined in the pending claims, in a reaction system having the specified water content. Even more surprising is the effect of the cutting direction on the thermal conductivity of the resulting boards given the cell nucleator has been added to reduce the size of the cells.

TABLE 2

| Example | | 5 | 6 | 7 | 8 |
|---|---|---|---|---|---|
| Polyol 1 | pbw | 83.6 | 83.6 | 83.6 | 83.6 |
| Polyol 2 | pbw | 16.4 | 16.4 | 16.4 | 16.4 |
| Fire retardant | pbw | 14.2 | 14.2 | 14.2 | 14.2 |
| Catalyst 1 | pbw | 0. | 0.6 | 0.5 | 0.5 |
| Catalyst 2 | pbw | 0.8 | 0.8 | 0.8 | 0.8 |
| Surfactant | pbw | 2.2 | 2.2 | 2.2 | 2.2 |
| Water | pbw | 0.7 | 1.0 | 1.3 | 1.6 |
| FA188 | pbw | 0.0 | 0.0 | 0.0 | 0.0 |
| Solstice Iba | pbw | 22.4 | 22.1 | 17.7 | 15.3 |
| Hydrocarbon | pbw | 0.0 | 0.0 | 0.0 | 0.0 |
| Polymeric | pbw | 134.4 | 139.9 | 145.4 | 150.8 |
| MDI | | | | | |
| Isocyanate | — | 115 | 115 | 115 | 115 |
| Index | | | | | |
| Density | Kg/m³ | 38.4 | 37.5 | 38.1 | 37.9 |
| Thermal | mW/ | 18.3 | 18.4 | 18.7 | 19.2 |
| conductivity | m · K | | | | |
| X-cut | | | | | |
| Thermal | mW/ | | | | |
| conductivity | m · K | | | | |
| Y-cut | | | | | |
| Compressive | kPa | 317 | 306 | 309 | 331 |
| strength CST | | | | | |
| Compressive | kPa | 103 | 99 | 103 | 102 |
| strength CSW | | | | | |
| Compressive | kPa | — | — | — | — |
| strength CSL | | | | | |
| Ratio CST/ | — | 3.08 | 3.09 | 3.00 | 3.25 |
| CSW | | | | | |

The foams of Table 2 are labfoams manufactured in moulds having the following dimensions l×b×h=200 mm×200 mm×250 mm.

Key to Table 2
Density, expressed as kg/m³, is the result of 1 labfoam, sample size (100×100×100)mm.
Thermal conductivity X-cut, expressed as mW/mK, measured at 10° C., sample size (190×190×50)mm—the 50 mm measurement is in the rise direction (X or height of the block).
Compressive strengths in the thickness (CST), width (CSW) and length (CSL) dimensions of a cubic sample of (50×50×50)mm cut from a panel having a thickness, width and length (i.e. a parellelepiped panel) was assessed as described above.

### Examples 5 to 8

The foams of examples 5 to 8, are foams blown with water and Solstice LBA with an apparent density of approximately 38 kg/m³. The foams were made on laboratory equipment. These examples 5 to 8 indicate the effect of increasing the water level on thermal conductivity which increases significantly when the amount of water increases above about 1.5 pbw per 100 pbw polyol. The level of 1 pbw has been set as optimum since lower levels do not decrease thermal conductivity and induce higher levels of Solstice LBA to reach the required density which increases the average cost of the foam.

Importantly, the present invention provides thermal insulating rigid polyurethane or polyisocyanurate foam boards having excellent thermal insulating performance, which are thinner than prior art foam boards.

For example Table 3 shows the thickness of prior art polyurethane foam boards having a thermal conductivity of 0.022 W/m·K, in comparison to rigid foam boards according to the present invention which have a thermal conductivity of 0.018 W/m·K.

TABLE 3
Thickness (mm)

| Conventional | | |
|---|---|---|
| PUR foam | PUR foam | |
| (cyclopentane/ | of the present | |
| isopentane) | invention | |
| (λ = 0.022 | (λ = 0.018 | Reduction |
| W/m · K)* | W/m · K)* | in thickness |
| 40.0 | 32.8 | 7.2 |
| 60.0 | 49.2 | 10.8 |
| 80.0 | 65.6 | 14.4 |
| 100.0 | 82.0 | 18.0 |
| 120.0 | 98.4 | 21.6 |

*thermal conductivity (λ) measured at Tₘₑₐₙ of 20° C..

The reduction in thermal conductivity implies boards of reduced thickness may be employed. In the context of a refrigeration body insulated with the rigid polyurethane or polyisocyanurate foam according the present invention this reduction in thickness represents a significant increase in the cargo space within the refrigeration body. Furthermore, in the context of a vehicle comprising a refrigerated body as described herein, the cost of running the vehicle is markedly reduced due to reduced fuel consumption as a consequence of a lighter refrigeration body and reduced cooling requirements as a consequence of the improved thermal insulating performance of the refrigeration body.

Moreover, the long lasting thermal insulating performance of the rigid polyurethane and polyisocyanurate foam boards of the present invention also increases the lifespan of refrigeration bodies comprising said boards. Thus vehicles comprising such refrigeration bodies will also have a longer lifespan.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A method of producing a polyurethane or polyisocyanurate foam, by reacting and curing of a foamable composition comprising:
a) at least one polyisocyanate,
b) at least one polyol component
c) a catalyst; and
d) a blowing agent;
the blowing agent comprises water and one or more halogenated hydroolefins selected from 1-chloro-3,3,3-trifluoropropene, 1-chloro-2,3,3,3-tetrafluoropropene, 1,3,3,3-tetrafluoropropene, 2,3,3,3-tetrafluoropropene and 1,1,1,4,4,4-hexafluoro-2-butene;
the water is present in an amount of from 0.2 parts by weight to 1.5 parts by weight per 100 parts by weight polyol;
e) a surfactant; and
f) a cell nucleator, the cell nucleator is one or more compounds having the formula: 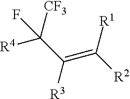
wherein R¹ is selected from —F, —CF₃, —CF₂CF₃ and —CF₂CF₂CF₃;
R² is selected from —F, CF₃, —CF₂CF₃ and —CF₂CF₂CF₃;
R³ is selected from —F, CF₃, —CF₂CF₃, —CF₂CF₂CF₃ and —CF(CF₃)₂; and
R⁴ is selected from —F, CF₃, —CF₂CF₃, —CF₂CF₂CF₃ and —CF(CF₃)₂.

2. The method of producing a polyurethane or polyisocyanurate foam according to claim 1, wherein the water is present in an amount of from 0.8 parts by weight to 1.2 parts by weight per 100 parts by weight polyol.

3. The method of producing a polyurethane or polyisocyanurate foam according to claim 1, wherein the cell nucleator has the formula: 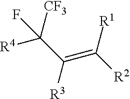
wherein R¹ is —F, or —CF₃;
R² is —F, or CF₃;
R³ is —F; and
R⁴ is CF₃.

4. The method of producing a polyurethane or polyisocyanurate foam according to claim 1, wherein the molar ratio of the cell nucleator to the one or more hydrofluoroolefins is in the range of from 1:16 to 1:46, preferably from 1:28 to 1:40, such as from 1:30 to 1:40.

5. The method of producing a polyurethane or polyisocyanurate foam according to claim 1, wherein the molar ratio of the cell nucleator to the water is in the range of from 1:8 to 1:16, preferably from 1:9 to 1:14, such as from 1:10 to 1:12.

6. The method of producing a polyurethane or polyisocyanurate foam according to claim 1, wherein the molar ratio of the cell nucleator to the one or more hydrofluoroolefins is in the range of from 1:28 to 1:40 and the molar ratio of the cell nucleator to the water is in the range of from 1:9 to 1:14.

7. (canceled)

8. The method of producing a polyurethane or polyisocyanurate foam according to claim 1, wherein the blowing agent further comprises a C₃-C₇ hydrocarbon selected from the group consisting of propane, butane, pentane, hexane, heptane and isomers thereof, including combinations thereof.

9. The method of producing a polyurethane or polyisocyanurate foam according to claim 1, wherein the blowing agent is present in an amount of from about 15 to about 30 parts by weight per 100 parts by weight polyol, such as from about 18 to about 25 parts by weight per 100 parts by weight polyol.

10. The method of producing a polyurethane or polyisocyanurate foam according to claim 1, wherein the catalyst comprises one or more amine catalysts and one or more organometallic catalysts.

11. (canceled)

12. The method of producing a polyurethane or polyisocyanurate foam according to claim 10, wherein the one or more organometallic catalysts comprises one or more organotin compounds.

13. The method of producing a polyurethane or polyisocyanurate foam according to claim 10, wherein the amine catalyst is present in an amount of from about 0.3 to about 0.8 parts by weight per 100 parts by weight polyol.

14. The method of producing a polyurethane or polyisocyanurate foam according to claim 10, wherein the organometallic catalyst is present in an amount of from about 0.5 to about 1.0 parts by weight per 100 parts by weight polyol.

15. The method of producing a polyurethane or polyisocyanurate foam according to claim 1, wherein the reactants further comprises one or more of a fluorinated oxirane, a perfluorinated tetrahydropyran, a perfluorinated tetrahydrofuran, a perfluorinated fluorene, and m-chlorofluorobenzene.

16. (canceled)

17. The method of producing a polyurethane or polyisocyanurate foam according to claim 1, wherein the surfactant comprises a polyether-polysiloxane copolymer.

18. The method of producing a polyurethane or polyisocyanurate foam according to claim 17, wherein the polyether-polysiloxane copolymer has a silicone content between 50 and 80% based on the total weight of the polyether-polysiloxane copolymer.

19. The method of producing a polyurethane or polyisocyanurate foam according to claim 1, wherein the surfactant is present in an amount of from about 1 to about 3 parts by weight per 100 parts by weight polyol, such as from about 1.5 to about 2.8 parts by weight per 100 parts by weight polyol.

20. (canceled)

21. (canceled)

22. (canceled)

23. The method of producing a polyurethane or polyisocyanurate foam according to claim 1, wherein said foam is manufactured using a continuous slabstock line.

24. (canceled)

25. (canceled)

26. A rigid polyurethane or polyisocyanurate foam board, comprising:
a plurality of cells in the foam board comprise a halogenated hydroolefin and a cell nucleator, the foam board having a density in a range of from 25 kg/m³ to 65 kg/m³, a closed cell content as determined in accordance with ASTM D 2856 of at least 90%, and a thermal conductivity when determined in accordance with ASTM C 518 of 0.018 W/m.K or less, at a mean temperature of 10° C.;
the halogenated hydroolefin is selected from 1-chloro-3,3,3-trifluoropropene, 1-chloro-2,3,3,3-tetrafluoropropene, 1,3,3,3-tetrafluoropropene, 2,3,3,3-tetrafluoropropene and 1,1,1,4,4,4-hexafluoro-2-butene; and
the cell nucleator is one or more compounds having the formula: 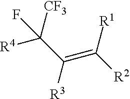
wherein R¹ is selected from —F, —CF₃, —CF₂CF₃ and —CF₂CF₂CF₃;
R² is selected from —F, CF₃, —CF₂CF₃ and —CF₂CF₂CF₃;
R³ is selected from —F, CF₃, —CF₂CF₃, —CF₂CF₂CF₃ and —CF(CF₃)₂; and
R⁴ is selected from —F, CF₃, —CF₂CF₃, —CF₂CF₂CF₃ and —CF(CF₃)₂.

27. The rigid polyurethane or polyisocyanurate foam board according to claim 26, wherein the cell nucleator has the formula: 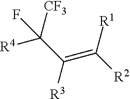
wherein R¹ is —F, or —CF₃;
R² is —F, or CF₃;
R³ is —F; and
R⁴ is CF₃.

28. The rigid polyurethane or polyisocyanurate foam board according to claim 26, wherein the cell nucleator is further comprised of

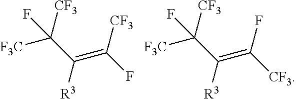

29. (canceled)

30. A refrigeration body comprising walls, a floor and a roof, at least one of the walls, floor or roof comprising one or more thermal insulating boards, the one or more thermal insulating boards comprise one or more rigid polyurethane or polyisocyanurate foam boards according to claim 26.

31. A vehicle comprising a refrigeration body according to claim 30.

32. An external thermal insulation composite system (ETICS) comprising a thermal insulating layer, fastening means and a finishing layer, the thermal insulating layer comprises a rigid polyurethane or polyisocyanurate foam board according to claim 26.

33. An insulated building wall comprising an ETICS according to claim 32, and a building wall, wherein the ETICS is affixed to the building wall.
